(19) United States
(12) Patent Application Publication
(10) Pub. No.: US 2004/0078264 A1
(43) Pub. Date: Apr. 22, 2004

(54) Computer system for repeatedly utilizing marketing management resources and method therefor

(76) Inventor: Chin-Chun Li, Kaohsiung (TW)

Correspondence Address: Ladas & Parry, 26 West 61st Street, New York, NY, 10023, US

(21) Appl. No.: 10/274,810

(22) Filed: Oct. 21, 2002

(51) Int. Cl. G06F 17/60

(52) U.S. Cl. 705/14

(57) ABSTRACT

The present invention relates to a computer system for repeatedly utilizing marketing management resources. The computer system mainly comprises a database group, a designator means and an arrangement means. The designator selects a specific node of a specific database in the database group as a start node of a new database. The arrangement means arranges the nodes of the new database to have new orders and new ranks, wherein the members of the nodes of the new database are the members of the nodes of the specific database. According to the computer system of the invention, the marketing management resources “members” can be repeatedly utilized to set a new marketing management system and a new database. Because the arrangement means arranges the nodes of the new database to have new orders and new ranks, it is possible that the member with low rank in the specific database can be the new member with upper rank in the new database. The lower-ranking members in the specific database have opportunity to get the bonus.

### BACKGROUND OF THE INVENTION

1. Field of the Invention

The present invention relates to a computer system, more particularly, to a computer system for repeatedly utilizing marketing management resources, a method for repeatedly using marketing management resources and a computer-readable medium for recording computer-executable programs for executing the method.

2. Description of the Related Art

According to the conventional direct selling system, the earlier the joining time of a member is, the more bonus the member has, because the member can share the bonus of the low-ranking members. However, it is difficult to introduce others to be the low-ranking members, and the low-ranking members are usually few. Therefore, after the people participate in the conventional direct selling company, they usually stay in a stagnant stage. The members pay money to participate in the direct selling company, but most of them cannot get the bonus. Only few high-ranking members can get the bonus.

In a direct selling company, when the number of members reaches a saturation point, no more people want to participate in the direct selling company. Besides, the products of the direct selling company are usually expensive and few. Therefore, conventional direct selling companies tend to close.

Furthermore, when a new direct selling company is open, people urgently participate the new direct selling company having a doubtful future, and buy many useless products. People usually waste much money, but still hardly get the bonus. Though people do become high-ranking in the new direct selling company, they still must work hard on introducing others to be their low-ranking members.

Therefore, it is desirable to provide a novel and creative computer system to overcome the above problems.

### SUMMARY OF THE INVENTION

One objective of the present invention is to provide a computer system for repeatedly utilizing marketing management resource. The computer system mainly comprises a database group, a designator means and an arrangement means. The designator selects a specific node of a specific database in the database group as a start node of a new database. The arrangement means arranges the nodes of the new database to have new orders and new ranks, wherein the members of the nodes of the new database are the members of the nodes of the specific database. According to the computer system of the invention, the marketing management resource “members” can be repeatedly utilized to set a new marketing management system and a new database.

Another objective of the present invention is to provide a computer system for repeatedly utilizing marketing management resource. Because the arrangement means arranges the nodes of the new database to have new orders and new ranks, it is possible that the member with low rank in the specific database can be the new member with upper rank in the new database. The later members in the specific database then have opportunity to get the bonus.

Still another objective of the present invention is to provide a method for repeatedly utilizing marketing management resource in order to obtain the above objects by executing the method in the above systems.

Still another objective of the present invention is to provide a computer-readable medium that records computer-executable programs for executing the method so that the computer system can be practiced.

Still other advantages of the present invention will become readily apparent by those skilled in the art from the following detailed description that is described by way of illustration of the drawings. As the invention will be realized, the invention is capable of other different embodiments, and its several details are capable of being modified in various respects, without departing from the invention. Accordingly, the drawings and description are to be regarded as illustrative in nature and not as restrictive.

### BRIEF DESCRIPTION OF THE DRAWINGS

FIG. 1 is a block diagram illustrating a computer system according to the present invention.

FIG. 2 is a tree structure of a database 100 according to the present invention.

FIG. 3 is a tree structure of a database 200 according to the present invention.

FIG. 4 is a tree structure of a database 300 according to the present invention.

FIG. 5 is a flow chart illustrating a method according to the present invention.

### DETAILED DESCRIPTION OF THE INVENTION

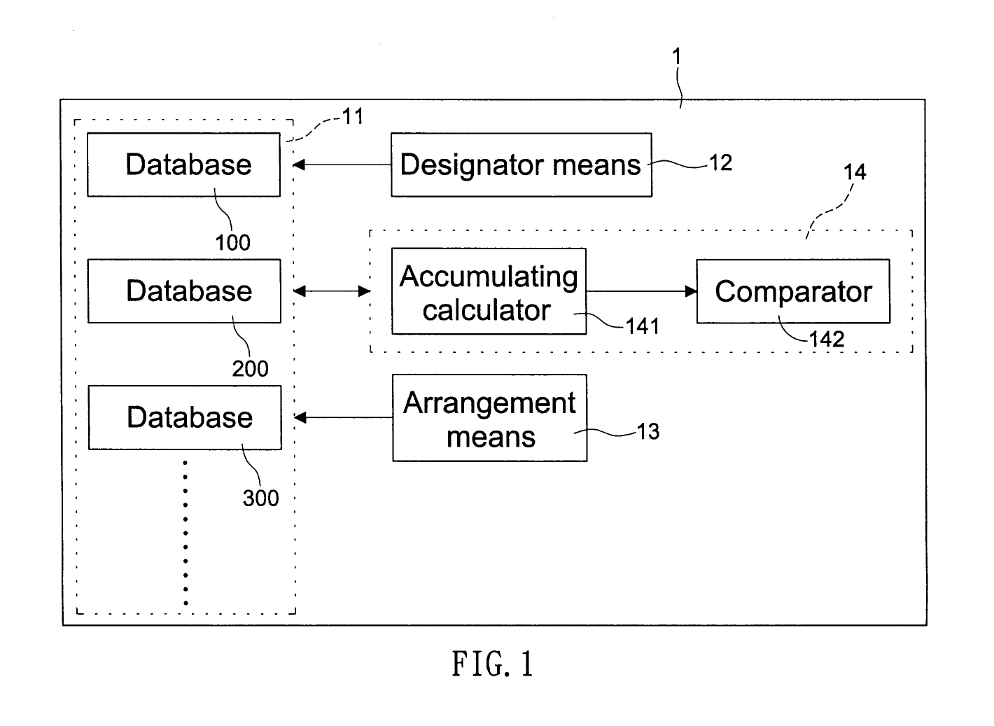

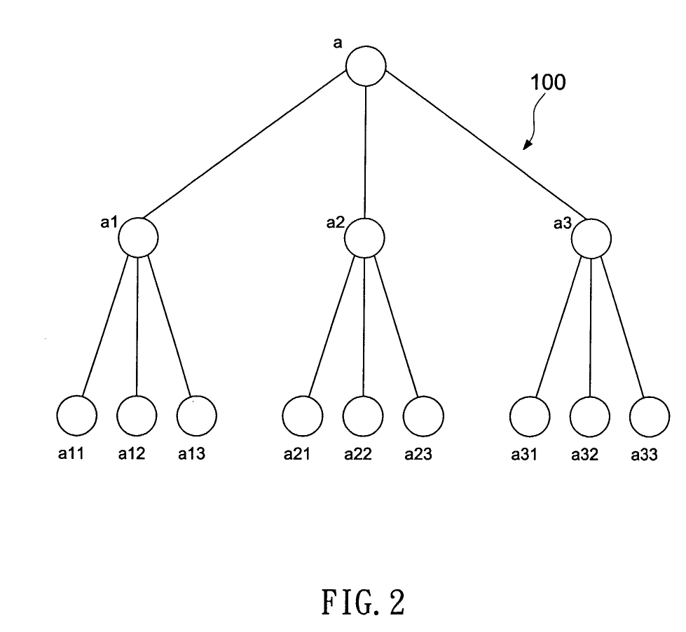

Referring to FIG. 1, a computer system 1 mainly comprises: a database group 11, a designator means 12 and an arrangement means 13. The database group 11 comprises a plurality of databases 100, 200 and 300. Each database has a plurality of nodes for storing the data of members. Each node has an order and a rank. Referring to FIG. 2, a tree structure 100 has a plurality of node (a) to (a33). Each node has three branches. Each branch links to a node of the next rank. The node (a) of the first rank links to three nodes (a1), (a2) and (a3) through the branches. The node (a1) of the second rank links to three nodes (a11), (a12) and (a13). Therefore, the node has a different rank with others.

Besides, for the nodes within the same rank, the left node is higher than the right node. For example, for the nodes (a1), (a2) and (a3) in the second rank, the node (a1) is higher than the node (a2), and the node (a2) is higher than (a3). Therefore, each node has a different order from others.

The designator means selects a specific node of a specific database as a start node of a new database. The arrangement means arranges the nodes of the new database to have new orders and new ranks, wherein the members of the nodes of the new database are the members of the nodes of the specific database.

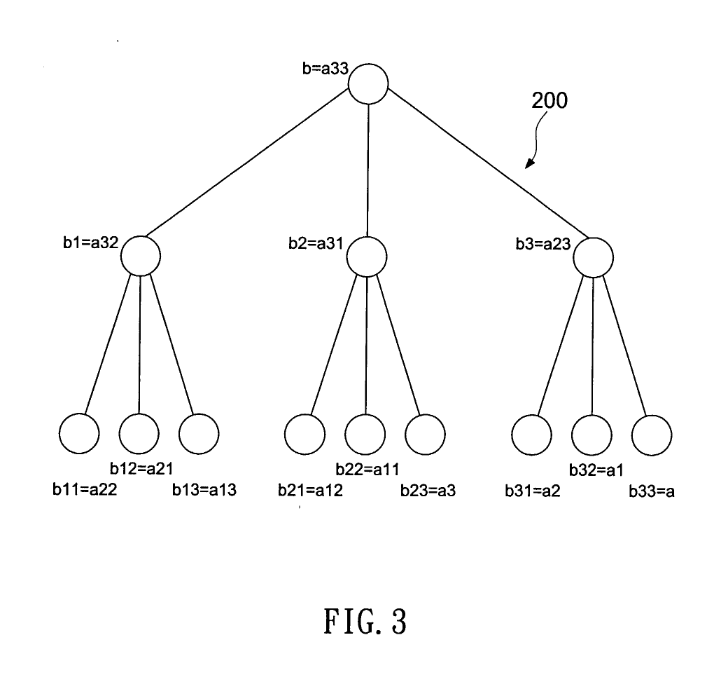

Referring to FIG. 2 and FIG. 3, the designator 12 selects the last node (a33) of the specific database 100 as a starting node (b) of the new database 200. The data of the member in the node (a33) is stored in the node (b). Therefore, the data of the node (b) is the same as that of the node (a33). By utilizing the members of the specific database 100, the arrangement means 13 arranges the nodes of the new database 200 to have new orders and new ranks in reverse order, different from those of the specific database 100.

As shown in FIG. 3, the data of the node (b1) is the same as that of the node (a32), and the data of the node (b2) is the same as that of the node (a31), and the data of the last node (b33) in the new database 200 is the same as that of the starting node (a) in the specific database 100. Therefore, the members of the new database 200 are shifted from the specific database 100, but the order of the nodes in the new database 200 is in reverse with that of the nodes in the specific database 100.

According to the computer system of the invention, the marketing management resource “members” can be repeatedly utilized to set a new marketing management system and a new database. It is possible that the member with low rank in the specific database can be the new member with upper rank in the new database. Therefore, when a new marketing management company is set, the later member in the specific database has opportunity to be the new member with upper rank and order, and does hardly need to introduce others to participate in the company. Accordingly, the computer system of the invention can solve the problems in the conventional direct selling company of without profit share for the later member, no new members participating in the company, and difficulty in introducing others to participate the company.

The computer system 1 further comprises a cycle calculator 14. The cycle calculator 14 comprises: an accumulating calculator 141 and a comparator 142. The accumulating calculator 141 calculates the accumulated bonus of the member in the block in a fixed period (e.g., a week). The comparator 142 compares the bonus of the member and a number limit of the specific database. If the bonus of the member is larger than the number limit, the member can be a new member of a new database. The arrangement means 13 arranges the new order and rank of the new node in the new database.

An embodiment is described as below, the computer system sets a start point and a time period, for example, a day before the establishment of a new marketing management company is set as a start point, and a week from the start point is set as a time period to calculate the bonus of each member in the specific database 100. The bonus is the total amount of commissions for promoting or selling goods or services. If the bonus of the members (a3) to (a33) is larger than the number limit of the specific database 100, the data of the members (a3) to (a33) are shifted into a new database 300. In the embodiment, the arrangement means 13 arranges the rank and the order of the new nodes of the new database 300 in the same order as that of the specific database 100.

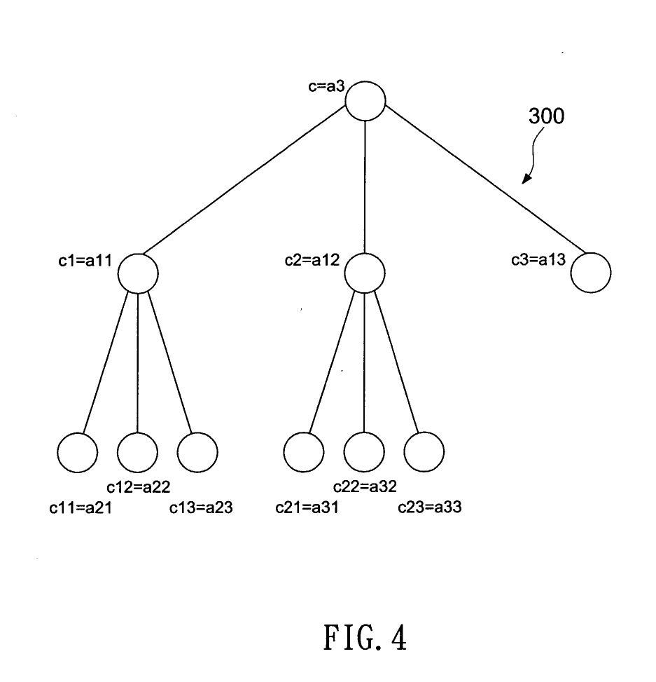

As shown in FIG. 4, the data of the node (c) is the same as that of the node (a3), and the data of the node (c1) is the same as that of the node (a11), and the data of the node (c2) is the same as that of the node (a12), and the data of the last node (c23) in the new database 300 is the same as that of the start node (a33) in the specific database 100.

Given the above, the same order or the reverse order are not a limitation, but an example. The arrangement means 13 can arrange the order in every other node or in every other two nodes. Both the same order and the reverse order can be used together to arrange the new database. Besides, by the designator 12, the last node of the specific database is not the only choice for a start node of the new database; any nodes of the specific database could be a start node of the new database.

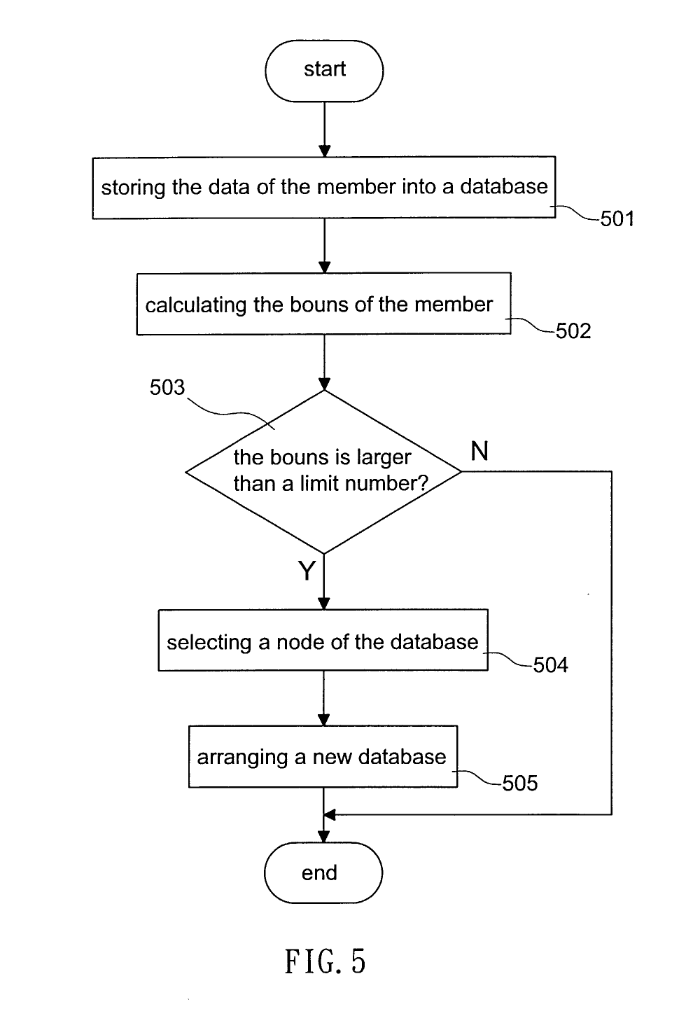

Referring to FIG. 5, the flow chart illustrates the method according to the present invention. In step 501, the data of the member is stored in a database of a database group. Each database has a plurality of nodes for storing the data of members. Each node has an order and a rank. In step 502, the bonus of the member in a database is calculated in a fixed period. In step 503, the bonus of the member compares with a number limit. If the bonus of the member is larger than the number limit, the member can be a new member of a new database. In step 504, a member qualified to be a new member is selected to be a start node of the new database. The nodes of the new database are arranged to have a new order and a new rank in suitable arranging method, as shown in step 505. Therefore, according to the above steps of the invention, the new database can be set, and the nodes of the new database are shifted from the nodes of the specific database so that the marketing management resource can be repeatedly utilized.

Computer programs can implement the above method. The programs can be loaded into a computer or a programmable information processor to execute the function of the flow chart of FIG. 5. The programs can be stored in a computer-readable medium (for example, magnetic tape, magnetic disc, compact disc, hard disc and IC memory, etc) for future loading into the computer. Therefore, the invention further provides a computer-readable medium recording computer-executable programs for the method of the invention.

While an embodiment of the present invention has been illustrated and described, various modifications and improvements can be made by those skilled in the art. The embodiment of the present invention is therefore described in an illustrative but not restrictive sense. It is intended that the present invention is not limited to the particular forms as illustrated, and that all the modifications not departing from the spirit and scope of the present invention are within the scope as defined in the appended claims.

We claim:

1. A computer system for repeatedly utilizing marketing management resources, comprising:
a database group, having a plurality of databases, each database having a plurality of nodes for storing data of members, each node having an order and a rank;
a designator means for selecting a specific node of a specific database as a start node of a new database; and
an arrangement means for arranging the nodes of the new database to have new orders and new ranks, wherein the members of the nodes of the new database are the members of the nodes of the specific database.

2. The computer system as claimed in claim 1, wherein a plurality of nodes form a tree structure, a plurality of branches are produced from the node, and the branch links to a node of the next rank so that the node has a different rank and order from the other nodes.

3. The computer system as claimed in claim 2, wherein three branches are produced from the node.

4. The computer system as claimed in claim 1, wherein the computer system further comprises a cycle calculator comprising:
an accumulating calculator for calculating a bonus of the member of the specific database in a fixed period;
a comparator for comparing the bonus of the member with a number limit of the specific database;
wherein the members of the nodes of the new database are the members whose bonus is larger than the number limit in the specific database.

5. The computer system as claimed in claim 4, wherein the fixed period is a week.

6. The computer system as claimed in claim 1 or 4, wherein the designator means selects a node with the last order of the specific database as the start node of the new database.

7. The computer system as claimed in claim 6, wherein the arrangement means arranges the rank and the order of the new nodes of the new database in the reverse order, different from that of the specific database.

8. The computer system as claimed in claim 1 or 4, wherein the arrangement means arranges the rank and the order of the new nodes of the new database to be the same as those of the specific database.

9. A method for repeatedly utilizing marketing management resources, comprising the steps of:
(a) storing data of members in a database of a database group, the database having a plurality of nodes for storing the data of members, each node having an order and a rank;
(b) selecting a specific node of a specific database as a start node of a new database; and
(c) arranging the nodes of the new database to have new orders and new ranks, wherein the members of the nodes of the new database are the members of the nodes of the specific database.

10. The method as claimed in claim 9, wherein a plurality of nodes of the database form a tree structure, a plurality of branches are produced from the node, and the branch links to a node of the next rank so that the node has a different rank and order from the other nodes.

11. The method as claimed in claim 10, wherein three branches are produced from the node.

12. The method as claimed in claim 9, wherein the method further comprises a calculating step comprising the sub-steps of:
calculating a bonus of the member in the specific database in a fixed period;
comparing the bonus of the member with a number limit of the specific database;
wherein the members of the nodes of the new database are the members whose bonus is larger than the number limit in the specific database.

13. The method as claimed in claim 12, wherein the fixed period is a week.

14. The method as claimed in claim 9 or 12, wherein the method further comprises a step of selecting a node with the last order of the specific database as the start node of the new database.

15. The method as claimed in claim 14, wherein the method further comprises a step of arranging the rank and the order of the new nodes of the new database in the reverse order, different from that of the specific database.

16. The method as claimed in claim 9 or 12, wherein the method further comprises a step of arranging the rank and the order of the new nodes of the new database in the same order as that of the specific database.

17. A computer-readable medium for recording computer-executable programs for executing a method for repeatedly utilizing marketing management resources, the method comprising the steps of:
(a) storing data of members in a database of a database group, the database having a plurality of nodes for storing the data of members, each node having an order and a rank;
(b) selecting a specific node of a specific database as a start node of a new database; and
(c) arranging the nodes of the new database to have new orders and new ranks, wherein the members of the nodes of the new database are the members of the nodes of the specific database.

18. The computer-readable medium as claimed in claim 17, wherein a plurality of nodes of the database form a tree structure, a plurality of branches are produced from the node, and the branch links to a node of the next rank so that the node has different rank and order from the other nodes.

19. The computer-readable medium as claimed in claim 18, wherein three branches are produced from the node.

20. The computer-readable medium as claimed in claim 17, wherein the method further comprises a calculating step comprising the sub-steps of:
calculating a bonus of the member in the specific database in a fixed period;
comparing the bonus of the member with a number limit of the specific database;
wherein the members of the nodes of the new database are the members whose bonus is larger than the number limit in the specific database.

21. The computer-readable medium as claimed in claim 20, wherein the fixed period is a week.

22. The computer-readable medium as claimed in claim 17 or 20, wherein the method further comprises a step of selecting a node with the last order of the specific database as the start node of the new database.

23. The computer-readable medium as claimed in claim 22, wherein the method further comprises a step of arranging the rank and the order of the new nodes of the new database in the reverse order, different from those of the specific database.

24. The computer-readable medium as claimed in claim 17 or 20, wherein the method further comprises a step of arranging the rank and the order of the new nodes of the new database in the same order as those of the specific database.
